(19) United States
(12) Patent Application Publication
(10) Pub. No.: US 2016/0129464 A1
(43) Pub. Date: May 12, 2016

(54) Network-Enabled Smart Shower Head Adapter

(71) Applicant: Jeffrey Mitchell Frommer, Hoboken, NJ (US)

(72) Inventor: Jeffrey Mitchell Frommer, Hoboken, NJ (US)

(21) Appl. No.: 14/938,831

(22) Filed: Nov. 11, 2015

Related U.S. Application Data
(60) Provisional application No. 62/078,386, filed on Nov. 11, 2014.

(51) Int. Cl. B05B 12/00; G05D 7/06; G05B 15/02; E03C 1/02

(52) U.S. Cl. CPC B05B 12/008; E03C 1/025; G05D 7/0635; G05B 15/02; E03C 2001/026

(57) ABSTRACT

According to embodiments of the disclosed technology, a shower-head adapter device, apparatus and method are used for measuring, controlling, recording and/or communicating water-use and related data pertaining to a water-emitting nozzle, such as a shower head. The adapter device may be fitted between a shower head and shower stem, or may be entirely incorporated into a shower head. The adapter device may contain several components utilized to perform one or more tasks. A shutter valve may restrict flow based on a user's preferences while another sensor measures temperature. A turbine flow meter within the device may measure flow rate and provide hydroelectric power to electrical components of the device. A CPU, having a processor and memory, may measure and record water flow data. A network adapter may communicate the recorded data via a network node to any network-connected device, such as, for example, a mobile phone.

### CROSS-REFERENCE TO RELATED APPLICATIONS

This application claims the benefit of U.S. Provisional Application No. 62/078,386, filed Nov. 11, 2014.

### FIELD OF THE INVENTION

The presently disclosed technology generally relates to water distribution, and more specifically to an adapter for a shower head and the like that measures water use parameters and controls water flow, while communicating measured data and receiving commands, both via a wireless network.

### BACKGROUND OF THE DISCLOSED TECHNOLOGY

Commercially available shower head designs include those having a shower head housing with one or more passageways for facilitating a desirable water flow from a nozzle. Furthermore, more complicated shower heads may have a surface with a plurality of passageways, or nozzle orifices which utilize a backing disk having a plurality of resilient and flexible nozzle tips protruding through the nozzle orifices. The resilient nozzles of these known shower heads allow for convenient elimination of the build-up of calcium or other deposits by manually flexing the resilient nozzles when it appears that material is collecting therein. In these known shower heads, the entire nozzle is formed of a resilient and flexible rubber which does not match the finish of, e.g., a brass or chrome shower head.

The use of adjustable shower heads and nozzles is also known in the prior art. Such adjustable shower heads are known to consist basically of familiar, expected and obvious structural configurations. Different shower head configurations of the prior art seek to fulfill varying objectives regarding the improvement and efficiency of water flow.

Water scarcity and resulting conservation efforts are becoming a major issue for many countries and cities. Recently, California and other U.S. States have passed and enacted legislation for regulating groundwater use. Future measures may result in increased restrictions of home water-use for citizens living in the Western portion of the United States. On a global scale, water scarcity is increasing vastly along with the global population. Alarmingly, according to the United Nations, water use has been growing at more than twice the rate of the population increase in the last century. As such, it is the duty of citizens to take measures to reduce water use and consumption. As water consumption is required to sustain life, one area where humans can reduce water use is in the context of bathing, showering, and other non food-preparatory water use.

As such an apparatus for monitoring water usage at a specific residential or commercial dwelling could be useful in supporting water conservation and cost saving. One example of an adjustable shower head employs a shower hose which may be in the form of a flexible tube protected by metal coils or in the form of a plastic hose optionally including braiding. In this example, the hose is generally linear and may be no more than 6 feet long. The shower head is held by a user and the user dictates where the water is sprayed. In theory, this should shorten showering time and therefore reduce water use, but its efficacy does not seem to be consistant. Further, when it is not in use, the hose hangs down into a bath tub or other bathroom fitting where it is often dirtied by contact with dirty water.

In another variant, the hose is hidden away in a chute, in which case it dirties an area that is inaccessible for cleaning. The hole often leads to water leaking under the bath tub and into the floor. Furthermore, these embodiments require a longer hose when the shower head is in use. As a result of shower hoses not being long enough, they are often damaged by the user pulling on them.

Anti-scolding pressure balance and thermostatic temperature control valves are becoming the norm in many bathroom plumbing fixtures. These devices are employed to minimize hot water burning and cold water shocks that can occur in a shower when a toilet is flushed or a nearby sink is turned on.

Other valves and nozzles also exist which seek to maximize showering efficiency. However, none of these technologies take concrete steps to effectively reduce water use in the shower. That is, none of these technologies measure, provide, and save pertinent shower water use statistics. Moreover, none of the technologies of the prior art provide an interactive and semi-automated way for users to reduce their water flowrate and shower durations, while maintaining a degree of user customization. Additionally, there is a need for the ability to monitor water usage in order to encourage water savings and promote careful conscientious use of water and energy resources.

Accordingly, there exists a need in the art for an adjustable shower or bath head or water supply valve with either analog or digital means for measuring and/or controlling certain parameters, such as shower duration, flow rate, total volume, and temperature, in order to overcome or supplement the above-noted shortcomings. The fulfills this need by providing a network-enabled smart shower head or shower assembly piece that measures, controls, and wirelessly transmits shower parameters with regard to a user, while consuming little to no power and achieving a minimalistic design.

### SUMMARY OF THE INVENTION

According to embodiments of the disclosed technology, apparatuses and methods are provided for a shower-head adapter device for measuring, controlling, recording and/or communicating water-use and related data pertaining to a water-emitting nozzle, such as a shower head. The adapter device may be fitted between a shower head and shower stem, or may be entirely incorporated into a shower head. The adapter device may contain several components utilized to perform one or more tasks. A shutter valve may precisely restrict flow based on a user's preferences while another sensor measures temperature. A turbine flow meter within the device may measure flow rate and/or provide hydroelectric power to electrical components of the device. A CPU, having a processor and memory, may measure and record water flow data. A network adapter may communicate the recorded data via a network node to a web server, a cloud-based server, a network device, and/or any other computing device. Future showers may be managed by the device by limiting water use and flow rate. Also, LED indicators and audible sounds may warn a bather when thresholds are reached or approaching.

Referring now to specific embodiments of the disclosed technology, a shower head adapter is used for electronically monitoring and regulating water flow through a nozzle. The shower head adapter may employ one or more of the following components, in no particular order: a) a body having at least a first end and a second end opposing the first end; b) an at least partially hollow conduit extending from the first end to the second end; c) a first aperture at the first end defined by the conduit, the first aperture adapted to receive a threaded nipple; d) a second aperture at the second end defined by the conduit, the second aperture adapted to receive a shower head; e) a flow meter disposed along the conduit for measuring flow rate of water through the conduit; f) an adjustable valve disposed within the conduit for precisely regulating water flow through the conduit; g) a processor and memory for reading and storing measured data; h) a network adapter for transmitting the measured data; i) a power source for powering one or more components of the shower head adapter; j) an adjustment means disposed on an exterior region of the body, wherein the adjustment means is coupled to the adjustable valve for externally toggling the valve; k) a motor for toggling the adjustable valve; l) an accessory port for connecting additional external components to the shower head adapter; and/or m) a first sensor disposed within the conduit for measuring water temperature.

In embodiments, the valve may be a shutter valve operable to increase or decrease water flow through the conduit in increments of 5% or more. The power source may be a battery, a hydroelectric turbine, a solar panel, and/or any other power source used in the art for providing electricity to small devices. The turbine may also be a flow meter, capable of measuring flow rate data of water passing by.

In another embodiment of the disclosed technology, a shower head adapter apparatus is used to measure and regulate water use. The shower head adapter apparatus may employ one or more of the following components: a) a body adapted to be releasably coupled between a shower fitting and a shower head such that flow of water is diverted through the body; b) an adjustable valve for metering flow through the body; c) a flow rate turbine for measuring water flow through the body; d) a processor; e) a network adapter; and/or f) a non-transitory computer-readable storage medium configured to store computer-readable instructions, wherein the computer-readable instructions, when executed by the processor, cause the shower head adapter to perform processes comprising: i) measuring a flow rate as determined by the flow rate turbine; ii) recording a duration of continuous water flow; and iii) transmitting the flow rate and duration via the network adapter to a network-connected device via a wireless network.

The network connected device may be, for example, a mobile computing device associated with a user. The computing device may alternatively be a tablet, laptop computer, desktop computer, smart TV, smart TV adapter, MP3 player, smart watch, smart glasses and/or any other computing device with network connectivity.

Additional processes may be carried out by: a) receiving instructions from the mobile computing device operable to cause the shower head adapter to adjust the adjustable valve based on inputted parameters; and/or b) populating the data and any prior data into a central repository server. The inputted parameters may cause the adjustable valve to automatically adjust when certain water flow thresholds are met.

In still another embodiment of the disclosed technology, method of monitoring and regulating water consumption uses a shower adapter device coupled in between a shower stem and shower head. The method is carried out by way of a non-transitory computer-readable medium storing computer-readable instructions that, when executed by a processor, cause the shower adapter device to carry out the method by: receiving data from one or more components of the adapter device, the components operable to measure time, flow rate and temperature of water flowing through the adapter device; b) logging the data to the computer-readable medium; c) transmitting the data via a wireless network using a wireless network adapter disposed within the adapter device; d) a step of displaying the data visually on a device associated with the user; e) receiving an input command from the device as entered by a user; and/or f) carrying out one or more automated actions with respect to the shower head in response to the received input command.

A better understanding of the disclosed technology will be obtained from the following brief description of drawings illustrating exemplary embodiments of the disclosed technology.

### BRIEF DESCRIPTION OF THE DRAWINGS

FIG. 1 shows a perspective view of a shower head adapter according to embodiments of the disclosed technology.

FIG. 2 shows a top plan view of a shower head adapter according to embodiments of the disclosed technology.

FIG. 3 shows a side elevation view a shower head adapter according to embodiments of the disclosed technology.

FIG. 4 shows a perspective view of a shower head adapter installed on a standard shower head according to embodiments of the disclosed technology.

FIG. 5 shows a front elevation cut-away schematic of a shower head adapter according to embodiments of the disclosed technology.

FIG. 6 shows a side elevation cut-away schematic of a shower head adapter according to embodiments of the disclosed technology.

FIG. 7 shows a high-level overview of a communication system employing a shower head adapter according to embodiments of the disclosed technology

FIG. 8 shows a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

The presently disclosed technology is a shower-head adapter device for measuring, controlling, recording and/or communicating water-use and related data pertaining to a water-emitting nozzle, such as a shower head. The adapter device may be fitted between a shower head and shower stem, or may be entirely incorporated into a shower head. The device is not limited to shower heads and may also be used on other fluid transporting plumbing fixtures, such as, but not limited to, bathtubs, sinks, toilets, bidets, outdoor hoses, and/or sprinklers. Additionally, the device may be used in conjunction with other fluid transporting systems or devices, such as devices that emit and/or transport hydrocarbons, natural gas, oil, gasoline, petrol, and/or any other type of fluid (liquid or gaseous).

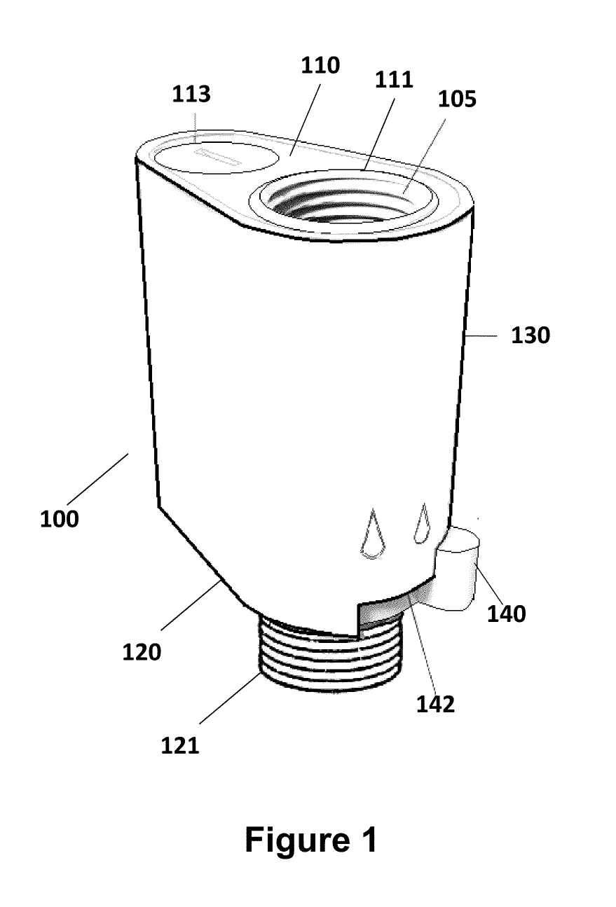

Referring now to the drawings, FIG. 1 shows a perspective view of a shower head adapter according to embodiments of the disclosed technology. The shower head adapter device (hereinafter interchangeably referred to as “adapter 100” and/or “shower head adapter 100”) is depicted. The shower head adapter 100 is generally formed of a body 130. The body 130 may be slightly elongated as depicted in the FIG. 1, but numerous variations are possible as would be known to one skilled in the field of art of the presently disclosed technology.

The body 130 may generally have a top end 110 (also referred to as “first end” for purposes of the specification and claims) and a bottom end 120 (also referred to as “second end” for purposes of the specification and claims). The top end 110 may have a first aperture 111 for coupling said adapter 100 to a shower stem or other threaded nipple. As such, the first aperture 111 may be a female-type threaded connection adapted to receive a male-type threaded connector.

A second aperture 121 extends from the bottom end 120 of the adapter 100. Contrastingly, the second aperture 121 may have external threads adapted to receive a female-type connector, such as that found on many shower heads and other nozzles. A conduit 105 is a hollow or semi-hollow passage defined within said body 130, terminating at the respective first aperture 111 and second aperture 112. As such, the conduit 105 provides a direct route for the flow of water through the adapter 100.

A lever 140 extends orthogonally from the adapter 130. The lever 140 is slidable within a recess or track 142 for adjusting the flow of water through the adapter. Markers may indicate to user which direction to move the lever 140 to increase or decrease flow. Portions of the adapter 100 may may be fabricated from a number of polymeric materials, such as polyvinyl chloride (PVC), polyethylene, polybutylene, acryaontirile-butadiene-styrene (ABS), rubber modified styrene, polypropylene, polyacetal, polyethylene, or nylon. Further, other portions of the adapter 100 may be composed of in brass, brass alloys, steel, galvanized steel, copper, copper allows or any combination thereof. Light emitting diodes (“LEDs”) may be disposed around the exterior of the body 130. The LEDs may serve as indicator lights, and may display different colors and/or patterns to alert the user of specific information concerning the adapter 100.

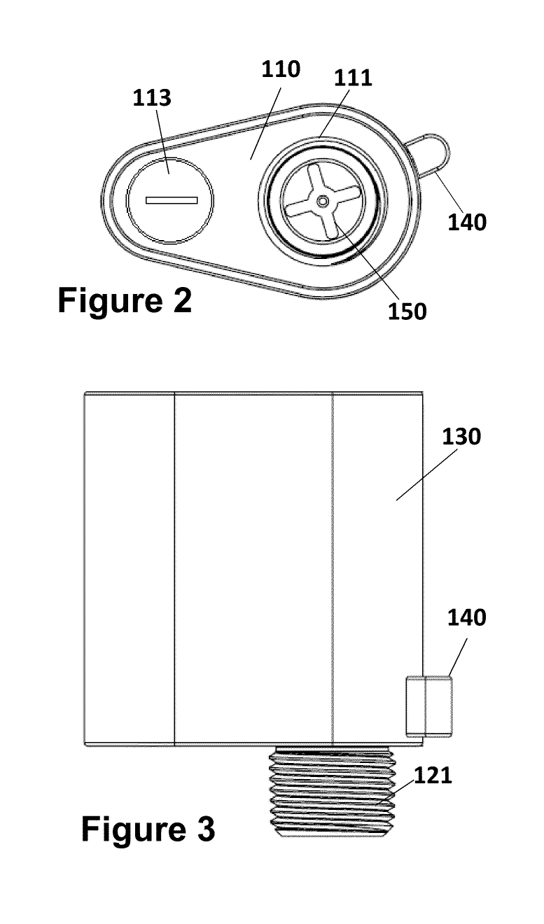

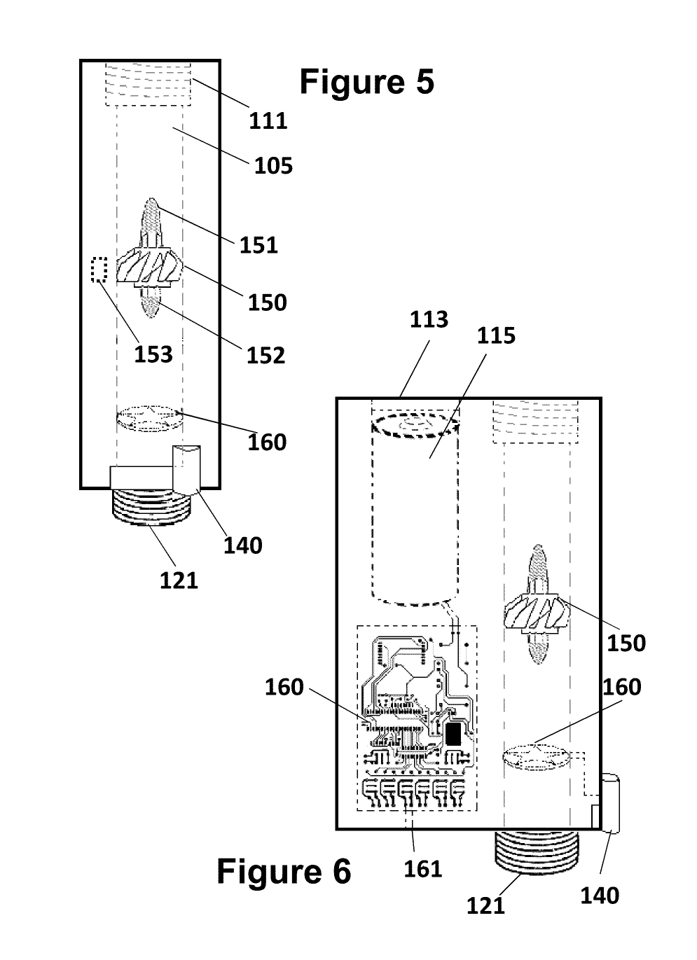

FIG. 2 shows a top plan view of a shower head adapter according to embodiments of the disclosed technology. FIG. 3 shows a side elevation view a shower head adapter according to embodiments of the disclosed technology. A water-tight door 113 provides access to interior components of the adapter 100. These components may include electrical and computational components and thus are best concealed in a water-proof region of the adapter 100. Also apparent in FIG. 2 is the existence of a turbine 150 within the conduit 105. In an embodiment, the turbine 150 may be a flow meter turbine or water displacement wafer. Alternatively, the turbine 150 may additionally or alternatively be a hydroelectric turbine capable of generating electricity from the flow of water past the turbine 150. These features and components will be described in greater detail with respect to FIGS. 5 and 6.

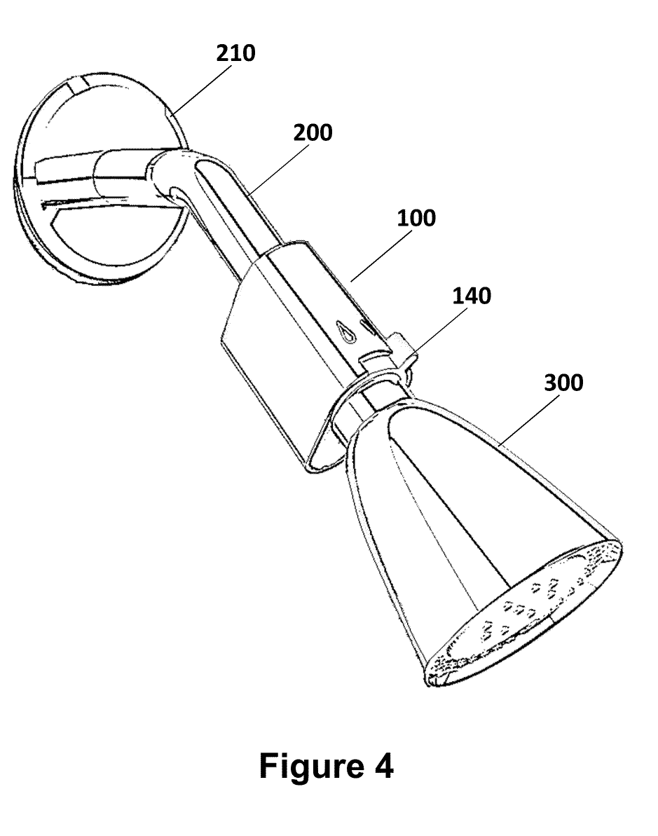

FIG. 4 shows a perspective view of a shower head adapter installed on a standard shower head according to embodiments of the disclosed technology. The adapter device 100 is depicted in a fixed position, coupled between a stem 200 and a shower head 300. The adapter 100 is attached to the shower or bath head's water supply piping/stem 200 extending from a typical shower or bath wall 210, a water pipe union or joint, and/or an articulated joint mechanism. The shower stem 200 is the portion of the shower that is connected to a live water line to provide water to be emitted through the shower head 300. The stem 200 may be any liquid dispensing tap and need not be limited to a lavatory shower application. For example, the stem 200 may be that of any fluid transporting systems or devices, such as devices that dispense and/or transport hydrocarbons, natural gas, oil, gasoline, petrol, and/or any other type of fluid (liquid or gaseous). Likewise, other standard water dispensing configurations, such as a faucet tap or an outdoor hose tap, may have a stem 200 onto which the adapter 100 of the presently disclosed technology may be used.

The shower head 300 may be, in an exemplary embodiment, a perforated nozzle that distributes water at a solid angle over a focal point of use, generally overhead a bather. Thus, in an embodiment, the adapter 100 is installed between the shower stem 200 and shower head 300. The threads of the adapter 100 enable it to be threaded onto both the shower stem 200 and the shower head 300 with relatively little effort, thereby not requiring the use of tools, the opening of walls, the drilling of holes, or a plumbing contractor.

As depicted, the adapter 100 is minimalistic in size and form, and maintains an aesthetically pleasing appearance of a shower head assembly. The adapter 100, when installed, is barely noticeable to a casual user as it meticulously blends in which the finish and construction of the shower head assembly. The adapter 100 may be so compact that it does not significantly alter the length and/or appearance of the shower head 200. Further, the adapter 100 may be finished in brass, brass alloys, steel, galvanized steel, copper, copper allows or any combination thereof in order to match a shower head assembly onto which it is used. The body 130 may be painted white or colored finishes or coated with various brass, silver and gold type materials to match the preexisting finish.

FIG. 5 shows a front elevation cut-away schematic of a shower head adapter according to embodiments of the disclosed technology. The flow meter turbine 150 resides within the through passing conduit 105. A top rotor support 151 and a bottom rotor support 152 stabilize the turbine 150 and ensure flow past the turbine is uniform and thus easier to measure. The flow meter turbine 150 may use the mechanical energy of the fluid to rotate “pinwheel” blades in the flow stream. The blades on the rotors are angled to transform energy from the flow stream into rotational energy. The rotor shafts spin on bearings. When the fluid moves faster, the rotor spins proportionally faster. Shaft rotation can be sensed mechanically or by detecting the movement of the blades. In an alternative embodiment, any other type of metering device may be used and incorporated into the adapter 100. Possible water metering mechanisms and devices may include, but are not limited to, displacement water meters, velocity water meters, multi-jet meters, turbine meters, fire meters, compound meters, electromagnetic meters, and/or ultrasonic meters.

Blade movement is often detected magnetically, with each blade or embedded piece of metal generating a pulse. One or more flow meter turbine sensors 153 are typically located external to the flowing stream to avoid material of construction constraints that would result if wetted sensors were used. When the fluid moves faster, more pulses are generated. A transmitter associated with the sensor may process the pulse signal to determine the flow of the fluid. In further embodiments, the flow meter 150 may incorporate the functionality of a flow computer (not shown) to correct for pressure, temperature and fluid properties in order to achieve the desired accuracy for the application. This computer would be separate and distinct from the later-described CPU and processor in reference to FIGS. 6 through 10.

The turbine 150 may be included in addition to or as an alternative to a battery 115. As such, the turbine 150 may be adapted to generate power in the form of electricity in order to power the rest of the components of the device. As water flows past the turbine 150, blades of the turbine are caused to rotate, thereby producing hydro-electric power using the generator. In addition to providing power, the rotation of the hydroelectric turbine may also be used to measure and compute flow rate and other variable information regarding water use. The electricity generated may be stored in a rechargeable battery 115 or may be used to directly power components of the adapter in battery-less embodiments.

FIG. 6 shows a side elevation schematic of a shower head adapter according to embodiments of the disclosed technology. A shutter valve 160 is also shown disposed within the conduit 105. The shutter valve 160 is coupled to the lever 140 for purposes of precisely increasing or decreasing flow through the adapter 100. In uniform water flow applications such as this, a shutter valve desirable because it is a bubble tight valve that provides a compact footprint, reduces water hammer, eliminates high frequency vibration and provides easy maintenance for greater uptime. However, any other type of valve may be used in conjunction with the disclosed technology. Such valves may include, but are not limited to, ball valves, butterfly valves, ceramic disc valves, clapper valves, check valves, non-return valves, choke valves, diaphragm valves, gate valves, globe valves, knife valves, needle valves, pinch valves, piston valves, plug valves, slim valves, poppet valves, spool valves, thermal expansion valves, pressure reducing valves, sampling valves, and/or safety valves. As will be discussed, the valve 160 may be coupled to a motor and/or CPU/processor such that the toggling of the valve may be fully or partially automated.

Referring still to FIG. 6, a battery 115 is depicted residing within a hollow region of the adapter 100. The battery 115 is concealed within the water-tight seal 113 on the top end 110 of the adapter 100. The battery 115 may be a one-time use battery or a rechargeable battery. The battery 115 may be any type of battery known or expected in the art, this includes, but is not limited to, lithium-ion, lithium-ion polymer, nickel-cadmium, alkaline, lead acid, nickel-iron, silicon air, silver-oxide, lithium-air, water-activated, zinc-air, silver-zinc, lithium-sulfur, lithium-titanate, lithium-iron phosphate, and/or any other type of battery.

Also shown in FIG. 6 is a CPU or microprocessor and associated circuitry mounted on an electronic circuit board 160 to control the operation of the adapter device 100 and communicate with the sensors, meters and/or other electrical components. The CPU or microprocessor and associated circuitry mounted on an electronic circuit board may also have the capability of being programmed for controlling certain features of the adapter 100. Also connected to the CPU is an accessory port 161 which may employ a data transfer means with a power line and a ground line. The accessory port 161 may be, for example, a universal serial bus (“USB”) port, such as a standard USB port, a micro-USB port, or a mini-USB port. The port 161 may be used to transmit data to and from the shower head adapter 100 to a computing device. The port 160 may also be used to charge the battery for powering the adapter. Still further, the port 160 may be used to add additional modules or components to the adapter device 100. For example, a Bluetooth or near-field communication dongle may be plugged into the port 160 to enable those features.

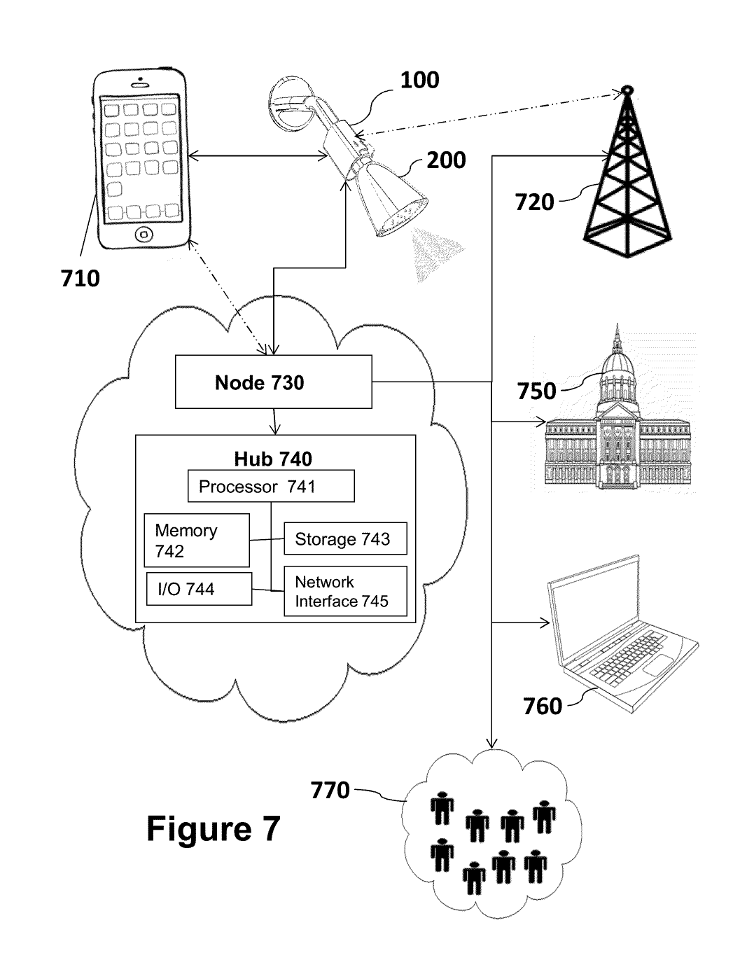

FIG. 7 shows a high-level overview of a communication system employing a shower head adapter according to embodiments of the disclosed technology. The shower head adapter device 100 may be installed in a standard household or apartment. The adapter 100 may be used by one or more users of the shower. However, for purposes of this example, the adapter 100 is used by a single user.

As discussed, the adapter 100 may have one or more mechanical and/or electrical components which measure & record data regarding water flowing through the adapter and/or the coupled shower head 200. The data may include, but is not limited to, flow rate (volume), time, temperature, velocity, water quality, etc. The adapter 100 may be wirelessly connected to a computing device, such as, for example, a mobile phone 710 as depicted in FIG. 7. Information and commands may be transmitted back and forth wirelessly between the mobile device 710 and the adapter 100. A wireless local area network (e.g. Wi-Fi), a packet-switched data network, near-field communication, Bluetooth, and/or any other wireless data transferring means may be used to create a bridge between the mobile phone 710 and the adapter 100. Examples of Bluetooth technologies (using the 2.4 GHz band as WiFi) that may be incorporated into the disclosed technology are the RN-4.1 Bluetooth modules, KC-41, KC 11.4, KC-5100, KC-216 or KC-225 data serial modules, and/or a BT-21 module. Examples of wireless network protocols that may be employed by the disclosed technology include, but are not limited to, the IEEE 802.11a, IEEE 802.11b, IEEE 802.11g and IEEE 802.11n modulation techniques. Applicants recognize that there are numerous wireless protocols that have been developed that, although not specifically listed, could be utilized with the present invention for data transfer purposes. Alternatively, a data transfer cable may be plugged into the accessory port 160 of the adapter 100 in order to download recorded data.

To summarize FIG. 7 from a macro perspective, data sent and/or received by the adapter may be communicated via a central node or repository, such as a cloud-based data warehouse or server. Such a data repository may be accessible by any device having internet connectivity via any network. The data may be processed, encrypted and/or decrypted at the node. From the central repository, data may be sent and received to/from multiple access points.

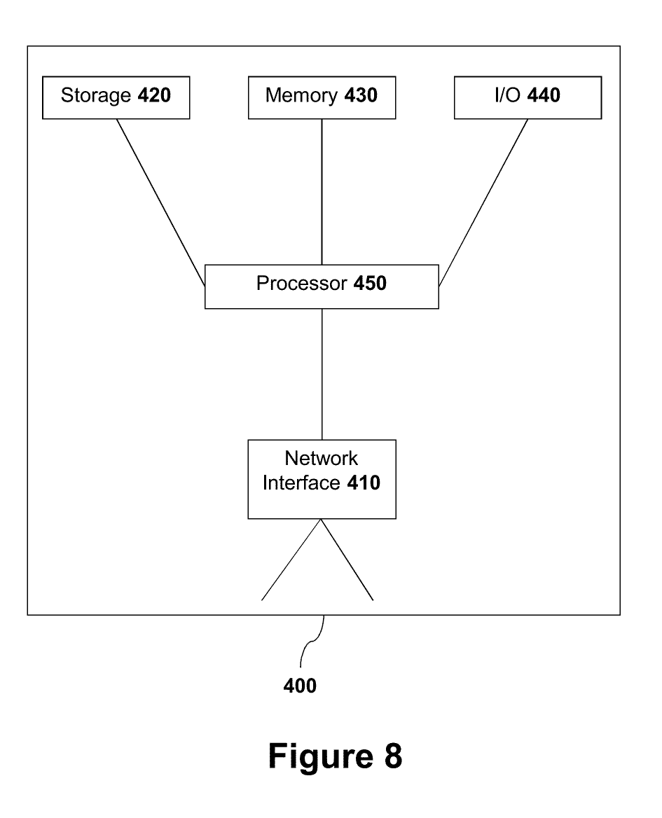

More specifically, the adapter 100 is in communication with a network node 730 and corresponding hub 740. The network node 730 may be disposed in the adapter 100 as an extension of and/or alternative to the CPU and processor. Alternatively, the network node 730 may exist externally, as a mobile device, computer, server, remote server, and/or any other device used to send, receive and store data electronically via a network. As such, the node 730 may be the mobile device 710 or at least in communication with it (as represented by the dotted line). The node 730 is a central repository for all of the data recorded and transmitted by the adapter 100. The node 730, may, for example, receive from the adapter 100 data after a completed shower. From there, the corresponding mobile device 710 or computing device 760 of an associated user may be updated. In further embodiments, the corresponding social networking profile 770 for the respective user may be updated. In an embodiment thereof, a hub 740 comprises a processor 741, memory 742, input/output 743, storage 744, and a network interface 745. These features correspond to those described in further detail below with regard to FIG. 8 and the description thereof, below.

As discussed, data recorded from the adapter 100 may be sent to an electronic computing device 760, such as a mobile phone, tablet, laptop computer, desktop computer, smart TV, smart TV adapter, MP3 player and/or any other computing device with network connectivity. Thus, a user may access various statistics from one or more shower sessions taken by the user or at a dwelling of the user. These statistics may include, for example, the length of a shower, a volume of water used during the shower, and/or an average temperature of the water used during the shower. For example, when the adapter 100 is monitoring the shower temperature of water flowing through the shower head 300, data may be collected and plotted on a temperature scale between 32 degrees Fahrenheit (0 degrees Celsius) and 212 degrees Fahrenheit (100 degrees Celsius), and within a reasonable range of 50 degrees Fahrenheit (10.0 degrees Celsius) and 150 degrees Fahrenheit (65.5 degrees Celsius). As per monitoring or measuring the rate of water flowing from a water source or through the shower head, data may be plotted and displayed on a mobile device showing flow between 0 gal/min (0 liters/hr) and 100 gal/min, within a reasonable range of 0.2 gal/min (liter/min) to 20 gal/min (liters/min). After the shower has been finished, as indicated by a cessation of flow past the turbine, data may be communicated to the device regarding the total volume of water that has been used (e.g. 23 gallons) and the total duration of the shower (e.g. 8 minutes).

Given these statistics, the amount of money spent on a water and/or heating bill may also be computed and displayed to the user. The amount may be extrapolated to yield an approximation of daily, weekly, monthly and/or yearly utility bills. Likewise, real time data from a user's utility bill may be inputted manually by the user or automatically populated from a utility bill paying account associated with the user or the physical address at which the adapter is used. Going a step further, the application may incorporate a database including local utility providers as well as standard utility costs associated with a given geographic region. In this embodiment, the application and/or the shower head adapter may communicate directly with the municipality or utility company 750. In this regard, the utility company 750 may be able to offer real-time incentives and savings to consumers for reducing their utility costs. In turn, the utility companies 750 may receive incentives, grants, and/or other funding from local or federal government for reducing power consumption thereby reducing greenhouse emissions and a resulting ecological footprint.

As previously alluded to, the user may be able to communicate with and manipulate the operation of the shower via the adapter 100 using a mobile device 710. For example, the user may be able to limit the length of future showers via an application installed on the mobile device 710 of the user. As such, if the user chooses to limit future showers to three minutes, the adapter 100 will cut the flow of water through the showerhead after three minutes of flow have elapsed. The application may be a mobile software application operable on any mobile computing operating system, such as, Windows, Android, iOS, Linux, OS X, BSD, QNX, etc. The application may be available to any users having access to an application database associated with his or her computing device.

In addition to the aforementioned features, the application may also compute and/or suggest possible water-use cutbacks and their corresponding utility savings. For example, the application may compute that if a user shortens his or her average shower length from four minutes to three minutes, that user may save approximately $250 on utility bills over the course of a year. The application may also be carried out on a third-party computing device that receives the shower data via the network node 730 as opposed to directly from the adapter 100. The adapter 100 may also transmit data via a third-party wireless network 720, such as a packet-switch data network.

Referring still to FIG. 7, shower statistical data may also be shared via an interactive social network or community 770. For example, acquaintances that are all part of the same social network or community may compete with one another to have the smallest ecological footprint. Those sharing their cutbacks in water usage via a social network may receive incentives from third parties, such as consumer product manufacturers or food & beverage companies. Users sharing their data may also be entered into contests and/or promotions sponsored by various companies.

The shower head adapter may be controlled remotely from a computing device or phone 710. The software application may be used to toggle the state of the shower from a remote location via a wireless network. Users may not only control whether a shower is running via the application, they may also control and configure the temperature of the water flowing through the adapter and out of the shower head. For example, because the adapter 100 acts as a valve, the original shower controls may be left in an “on” position at the desired water temperature. Therefore, the turning on and off of the shower may be controlled by the adapter 100. Likewise, in a more complicated embodiment, the adapter 100 may reduce flow rate by, for example, 50% after a pre-specified volume of water has been used or a pre-specified duration of time has passed. The possibilities for this type of feature are endless as many factors such as temperature (e.g. hot water use), volume, time and any other variable may be metered, altered or enjoined entirely. All of this may be pre-configured by a user using the application. Once parameters are entered, the adapter 100 will undergo a custom algorithm upon initiation of every showing session.

To give insight into the extent of these capabilities, the foregoing example is provided with respect to a father setting parameters for a home shower for his daughter. Firstly, the father may set temperature boundaries to protect his daughter from being scalded by hot water or experiencing overly cold water. Thus, the father may set the maximum shower temperature to 130° F. and minimum shower temperature to 100° F. Should the water temperature go outside this range, the adapter 100 may automatically cut off or drastically reduce flow using the valve. Next, the father may set a maximum shower duration of 10 minutes, after which, the flow of water is cut off. However, the father may also choose to reduce water flow by 20% after 7 minutes of showering have elapsed. Flashing LEDs and/or audible alarms may notify the bather of these time intervals having elapsed. All of these measures may be carried out via the associated application.

However, in an alternative embodiment of the disclosed technology, a button, lever, or microphone associated with the adapter may be used instead to toggle the state of the shower. In this embodiment, a user may program the adapter 100 directly, using one or more buttons, levers, and/or other inputs on the adapter 100. In a more complex embodiment, the adapter may have multiple components which are coupled to incoming hot and cold water lines. In this embodiment, the temperature may more accurately be set, changed and controlled remotely using a network-enabled device.

In an alternative embodiment of the disclosed technology, a shower head adapter 100 may lack wireless connectivity but may instead have a display or meter attached thereto. The display may show water usage statistics and may include input/output features so that a user may configure and toggle different features and settings of the adapter 100.

Additional components may include a microphone and/or a speaker. The microphone may be used to record memos by the user while in the shower. These memos may be transcribed into readable text and forwarded to a computing device or phone of the user for future reference. The microphone may also be used to receive voice commands from the user for actions to be taken by the adapter. The microphone may also be used to receive voice commands from a user to toggle the state of certain components. For example, a user may tell the adapter device 100 to reduce the flow rate by 10% in the middle of a shower. The speaker may be used to emit sounds to the user. The sounds may include relevant facts & statistics regarding water use and showering. For example, after four minutes has elapsed, instead of turning the shower off, the speaker may warn the user that his or her shower has exceeded four minutes. The speaker may also be configured to play music and previously recorded memos to the user.

In a still further embodiment of the disclosed technology, the adapter 100 may also include a water filter or water filtration assembly. This embodiment may be particularly useful for drinking water drawn from sink faucets, but may also purify water for purposes of bathing. Still further, sensors may be included within the adapter for measuring certain properties of the water. These sensors may measure pH, temperature, turbidity, alkalinity, conductance, dissolved oxygen, mineral content, hardness, fluoride-content, and other relevant water properties. These sensors may alternatively be added to the adapter 100 by way of the accessory port 160. These measurements may be recorded, stored, and transmitted via the wireless network card.

FIG. 8 shows a high-level block diagram of a microprocessor device that may be used to carry out the disclosed technology. The device 400 may or may not be a computing device. The device 400 may refer to the entire CPU described in the preceding paragraphs with respect to FIGS. 1 through 7, or a portion thereof. The device 400 may be, or may contain the network node 730 of FIG. 7. The device 400 employs a microchip (also referred to as “a smart chip”) and/or processor 450 that controls the overall operation of a computer by executing the reader's program instructions which define such operation. The device's program instructions may be stored in a storage device 420 (e.g., magnetic disk, database or non-transitory storage medium) and loaded into memory 430 when execution of the console's program instructions is desired. Thus, the device's operation will be defined by its program instructions stored in memory 430 and/or storage 420, and the console will be controlled by the processor 450 executing the console's program instructions. The processor 450 may process the data supplied by the temperature sensor, flow meter and any timing mechanisms. The processor 450 may use internal instructions to control the information that is sent wirelessly. The processor 450 can include an EEPROM or any type of memory section that allows for specific programming to be incorporated as processing instructions. Furthermore, the processor 450 may have the capability to convert analog signals into digital information for decoding and processing.

The device 400 may also include one or a plurality of input network interfaces for communicating with other devices via a network (e.g., the internet). The device 400 further includes an electrical input interface for receiving power and data from a power or wireless data source. The device 400 may also include one or more output network interfaces 410 for communicating with other devices. The device 400 may also include input/output 440 representing devices which allow for user interaction with a computer (e.g. buttons, display, keyboard, mouse, speakers, etc.).

One skilled in the art will recognize that an implementation of an actual device will contain other components as well, and that FIG. 8 is a high level representation of some of the components of such a device for illustrative purposes. It should also be understood by one skilled in the art that the devices depicted and described with respect to FIGS. 1 through 7 may be implemented on a device such as is shown in FIG. 8. Thus, the device 400 of FIG. 8 may describe the inner workings of the adapter 100 and/or any of its sensors or components.

FIG. 8 and any pertinent claims, description, and drawings of this application may describe one or more of the instant technologies in operational/functional language, for example as a set of operations to be performed by a computer, CPU, and/or processor of the shower head adapter device 100. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail above, the operational/functional language must be read in its proper technological context, i.e., as concrete specifications for physical implementations. That is, any electronically assisted functions of the shower head adapter device serve to improve the efficiency of consumer water-use in a showering and/or bathing context.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Nov. 11, 2015, 22:00 ET). In order to facilitate human comprehension, in many instances, high-level programming languages resemble or even share symbols with natural languages. See, e.g., Wikipedia, Natural language, http://en.wikipedia.org/wiki/Natural_{—} language (as of Nov. 11, 2015, 22:00 ET).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Nov. 11, 2015, 22:00 ET).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Nov. 11, 2015, 22:00 ET).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Nov. 11, 2015, 22:00 ET).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language. This machine language is carried out by one or more components of the shower head adapter device. For example, recording and sending of water-use data via a wireless network performed by the network adapter of the device executing machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the specification and any future claims are to be embraced within their scope. Combinations of any of the methods, systems, and devices described hereinabove are also contemplated and within the scope of the invention. Accordingly, the foregoing description should not be read as pertaining only to the precise structures described and shown in the accompanying drawings, but rather should be read as consistent with and as support for any claims which may be appended to any application claiming priority to the present application, which are to have their fullest and fairest scope.

Although exemplary systems and methods are described in language specific to structural features and/or methodological acts, the subject matter defined in the future claims is not necessarily limited to the specific features or acts described. Rather, the specific features and acts are disclosed as exemplary forms of implementing the claimed systems, methods, and structures.

Moreover, means-plus-function clauses in the future claims cover the structures described herein as performing the recited function and not only structural equivalents but also equivalent structures. Thus, a nail and a screw may not be structural equivalents because a nail employs a cylindrical surface to secure parts together and a screw employs a helical surface, but in the environment of fastening parts, a nail may be the equivalent structure to a screw. Applicant expressly intends to not invoke 35 U.S.C. §112, paragraph 6, for any of the limitations of the claims herein except for claims which explicitly use the words “means for” with a function.

What is claimed:

1. A shower head adapter comprising:
a body having at least a first end and a second end opposing said first end;
an at least partially hollow conduit extending from said first end to said second end;
a first aperture at said first end defined by said conduit, said first aperture adapted to receive a threaded nipple;
a second aperture at said second end defined by said conduit, said second aperture adapted to receive a shower head;
a flow meter disposed along said conduit for measuring flow rate of water through said conduit;
an adjustable valve disposed within said conduit for precisely regulating water flow through said conduit;
a processor and memory for reading and storing measured data;
a network adapter for transmitting said measured data; and
a power source for powering one or more components of said shower head adapter.

2. The shower head adapter of claim 1, further comprising an adjustment means disposed on an exterior region of said body, wherein the adjustment means is coupled to said adjustable valve for externally toggling said valve.

3. The shower head adapter of claim 1, further comprising a motor for toggling said adjustable valve.

4. The shower head adapter of claim 1, further comprising:
a first sensor disposed within said conduit for measuring water temperature;

5. The shower head adapter of claim 1, wherein said valve is a shutter valve operable to increase or decrease water flow through the conduit in increments of 5% or more.

6. The shower head adapter of claim 1, further comprising:
an accessory port for connecting additional external components to said shower head adapter.

7. The shower head adapter of claim 1, wherein said power source is a hydroelectric turbine disposed in said conduit.

8. The shower head adapter of claim 1, wherein said hydroelectric turbine is the flow meter.

9. The shower head of claim 1, wherein said power source is a battery disposed in said body.

10. A shower head adapter apparatus, comprising:
a body adapted to be releasably coupled between a shower fitting and a shower head such that flow of water is diverted through the body;
an adjustable valve for metering flow through said body;
a flow rate turbine for measuring water flow through the body;
a processor;
a network adapter; and
a non-transitory computer-readable storage medium configured to store computer-readable instructions, wherein the computer-readable instructions, when executed by the processor, cause said shower head adapter to perform processes comprising:
measuring a flow rate as determined by said flow rate turbine;
recording a duration of continuous water flow; and
transmitting said flow rate and duration via said network adapter to a network-connected device via a wireless network.

11. The shower head adapter of claim 10, wherein said network-connect device is a mobile computing device associated with a user.

12. The shower head adapter of claim 11, wherein said shower head adapter further performs processes comprising:
receiving instructions from said mobile computing device operable to cause the shower head adapter to adjust said adjustable valve based on inputted parameters.

13. The shower head adapter of claim 12, wherein said inputted parameters cause said adjustable valve to automatically adjust when certain water flow thresholds are met.

14. The shower head adapter of claim 10, wherein said shower head adapter further performs processes comprising:
populating said data and any prior data into a central repository server.

15. A method of monitoring and regulating water consumption using a shower adapter device coupled in between a shower stem and shower head, wherein the method is carried out by way of a non-transitory computer-readable medium storing computer-readable instructions that, when executed by a processor, cause the shower adapter device to carry out the following steps:
receiving data from one or more components of said adapter device, the components operable to measure time, flow rate and temperature of water flowing through said adapter device;
logging said data to said computer-readable medium;
transmitting said data via a wireless network using a wireless network adapter disposed within said adapter device.

16. The method of claim 15, further comprising a step of displaying said data visually on a device associated with said user.

17. The method of claim 16, further comprising a step of receiving an input command from said device as entered by a user.

18. The method of claim 17, further comprising a step of carrying out one or more automated actions with respect to said shower head in response to said received input command.
